(19) United States
(12) Patent Application Publication
(10) Pub. No.: US 2012/0215644 A1
(43) Pub. Date: Aug. 23, 2012

(54) WATER USAGE ANALYSIS FOR ADVERTISING PURPOSES

(75) Inventor: Riccardo Vieri, Montespertoli (IT)

(73) Assignee: BRAINTEXTER, INC., Austin, TX (US)

(21) Appl. No.: 13/032,131

(22) Filed: Feb. 22, 2011

(51) Int. Cl. G06Q 30/00

(52) U.S. Cl. 705/14.69

(57) ABSTRACT

A particular method includes receiving first data that represents a first aggregate amount of water that is used by a plurality of customers during a first time period. Based on the first aggregate amount of water, a first number of potential television viewers during the first time period may be estimated. The method includes receiving second data that represents a second aggregate amount of water that is used by the plurality of customers during a second time period. Based on the second aggregate amount of water, a second number of potential television viewers during the second time period may be estimated. The estimated first number of potential television viewers and the estimated second number of potential television viewers may be used for advertising purposes (e.g., for adjusting advertising fees).

### FIELD OF THE DISCLOSURE

The present disclosure is generally related to targeted advertising.

### BACKGROUND

The advertising world is experiencing rapid, changes. Estimating a number of viewers of a television program may be a factor in determining an associated advertising fee to charge an advertiser. Further, gathering information about a potential customer may be useful in targeting advertisements that may be more relevant to the potential customer. It may be difficult for advertisers to accurately estimate the number of viewers of a television program and to gather useful information about potential customers for targeted advertising purposes.

### BRIEF DESCRIPTION OF THE DRAWINGS

FIG. 1 is a diagram of a particular illustrative embodiment of a system of analyzing water usage for advertising purposes;

FIG. 2 is a diagram of a particular illustrative embodiment of a system of targeting advertisements based on a water usage analysis;

FIG. 3 is a diagram of a particular illustrative embodiment of a system of analyzing water usage over multiple geographic regions;

FIG. 4 is a flow chart of a particular embodiment of a method of adjusting one or more advertising fees based on a comparison of an estimated number of potential television viewers during different time periods;

FIG. 5 is a flow chart of a particular embodiment of a method of identifying a targeted advertisement based on a water consumption rate; and

FIG. 6 is a flow chart of a particular embodiment of a method of identifying targeted advertisements to be communicated to one or more devices located in different geographic regions based on water usage data.

### DETAILED DESCRIPTION

Advertisers are seeking alternative ways to estimate the number of viewers of a television program and to obtain additional information about potential customers in order to better target advertisements. Aggregate water usage information (i.e., the total amount of water used by all users of a water system) may provide information that may be used by advertisers in order to improve a profile of aggregate television viewership. For example, aggregate water usage may vary by season (e.g., a university town with fewer residents during a semester break or a location where many residents are away on vacation). As another example, aggregate water usage may correlate with commercial breaks during a major sporting event. Spikes in water usage may correspond to an increased number of restroom visits during commercial breaks. Such information may be valuable to advertisers in gauging the effectiveness of an advertising campaign. Aggregate water usage information may represent an additional source of data to improve advertising models and/or modify advertising fees. By making existing water usage data available to an interested company, a water supplier may be able to receive additional revenue at little or no cost. When the water usage data indicates that potential viewership is lower, an advertiser may be able to negotiate a reduced advertising fee. Similarly, when the water usage data indicates that potential viewership is higher, a television content provider (e.g., a television network or a local television station) may be able to negotiate an increased advertising fee. A regional/national aggregator may use a model to acquire data from numerous locations to provide even more information to advertisers (e.g., water consumption patterns in different cities/states/regions).

Individual water usage information (i.e., the amount of water provided by a water supplier to a particular customer at a residence) may provide additional information to advertisers in order to target the particular customer when the water usage information satisfies a threshold water consumption rate (e.g., a high water consumption rate). For example, during hot weather, the customer may be watering the lawn more often. However, the customer may be able to reduce the amount of water consumed by installing a sprinkler system to water the lawn at night (e.g., at 3 A.M.) in order to avoid wasting water due to evaporation. As another example, low-flow shower head manufacturers may be interested in customers of the water supplier that use a large amount of water, since high water usage may suggest that a customer is over-consuming water with inefficient shower heads and may be more responsive to advertising for low-flow shower heads. As a further example, a low water consumption rate may be associated with an environmentally-conscious customer of the water supplier that may be more receptive to advertisements associated with an environmentally friendly product or service. As noted above, a water supplier (e.g., a water utility or a city water department) may be able to provide aggregate or individual water usage data and receive additional revenue at little or no cost, by making the water usage data available to an interested company. Further, water usage data from numerous geographical locations obtained from multiple water suppliers may provide additional information to advertisers (e.g., water usage information for potential customers in various geographical locations).

In a particular embodiment, a method includes receiving first data that represents a first aggregate amount of water that is used by a plurality of customers (of a water supplier) during a first time period. Based on the first aggregate amount of water used, a first number of potential television viewers during the first time period may be estimated. The method includes receiving second data that represents a second aggregate amount of water that is used by the plurality of customers during a second time period. Based on the second aggregate amount of water, a second number of potential television viewers during the second time period may be estimated. One or more advertising fees may be adjusted based on a comparison of the first number of potential television viewers and the second number of potential television viewers. As an illustrative example, aggregate water usage at the beginning of an early morning news program (e.g., a local morning news program at 6 A.M.) may be lower than aggregate water usage at the beginning of a subsequent morning news program (e.g., a national morning news program at 7 A.M.). The increased aggregate water usage may indicate that more potential television viewers are at home and awake during the later morning news program than the early morning news program.

In a particular embodiment, a non-transitory computer readable storage medium may include instructions that, when executed by a processor, cause the processor to receive water usage data that identifies a water consumption rate of each of a plurality of customers of a water supplier. The water consumption rate of a particular customer may be compared to a threshold water consumption rate. When the water consumption rate of the particular customer satisfies the threshold water consumption rate, a targeted advertisement to be communicated to the particular customer may be identified. Multiple targeted advertisements may be communicated to the particular customer. Further, multiple customers may be identified with water consumption rates that satisfy the threshold water consumption rate, and one or more targeted advertisements may be communicated to each of the identified customers.

In another particular embodiment, a method includes receiving first water usage data associated with a first aggregate amount of water that is used by a first plurality of customers of one or more water suppliers that are associated with a first geographic region. The method includes receiving second water usage data associated with a second aggregate amount of water that is used by a second plurality of customers of one or more water suppliers that are associated with a second geographic region. The first water usage data may be compared to the second water usage data in order to identify a first targeted advertisement to be communicated to one or more devices located in the first geographic region and to identify a second targeted advertisement to be communicated to one or more devices located in the second geographic region. As an illustrative example, one geographic region may be experiencing a drought, and increased aggregate water usage in that region may be associated with increased watering of lawns. In this case, the targeted advertisement may be related to water conservation. Another geographic region may not be experiencing a drought, and there may be no increase in aggregate water usage associated with increased watering of lawns. In this case, targeting an advertisement related to water conservation may not be as effective.

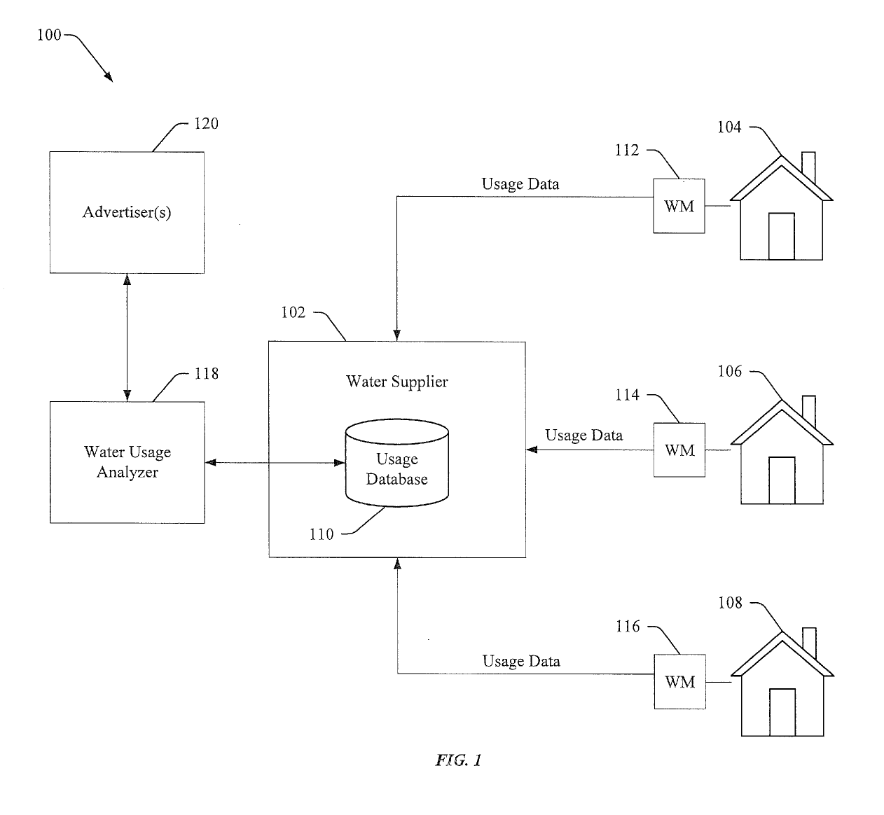

Referring to FIG. 1, a particular illustrative embodiment of a system of analyzing water usage for advertising purposes is illustrated and generally designated 100. The system 100 of FIG. 1 may measure or otherwise collect data related to an aggregate amount of water used by a plurality of customers or an amount of water used by a particular customer or set of customers for advertising purposes (e.g., for adjusting advertising fees or identifying targeted advertisements).

The system 100 includes a water supplier 102 that supplies water to a plurality of customers. For example, in the embodiment illustrated in FIG. 1, the water supplier 102 provides water to a first customer (e.g., at a first customer premises 104), to a second customer (e.g., at a second customer premises 106), and to a third customer (e.g., at a third customer premises 108). To illustrate, the water supplier 102 may be a city water company, a utility, a water district, or any other provider of water to multiple customers. In alternative embodiments, the water supplier 102 may supply water to any number of customers. While three customers are shown in FIG. 1 for illustrative purposes, there may be hundreds or thousands of total customers of the water supplier 102.

The system 100 includes a usage database 110 that stores water usage data associated with the plurality of customers. For example, a water consumption rate at the first customer premises 104 may be determined via a first water meter 112, a water consumption rate at the second customer premises 106 may be determined via a second water meter 114, and a water consumption rate at the third customer premises 108 may be determined via a third water meter 116. The system 100 further includes a water usage analyzer 118 (e.g., a computer program) that may utilize the water usage data stored at the usage database 110 to provide information to at least one advertiser 120. In the embodiment illustrated in FIG. 1, the water meters 112, 114, 116 are “smart” meters that communicate water usage data to the water supplier 102 (e.g., via wireless or wireline telemetry). Alternatively, the water meters 112, 114, 116 may be visually inspected by a technician, or the technician may be able to obtain water usage data information via wireless communication with the water meters 112, 114, 116. The water usage data may be automatically stored at the usage database 110 (e.g., when the water meters 112, 114, 116 communicate directly with the water supplier 102), or the water usage data associated with each of the water meters 112, 114, 116 may be manually input into the database (e.g., via a data entry person).

In a particular embodiment, the water usage analyzer 118 may be configured to receive first data that represents a first aggregate amount of water that is used by the plurality of customers during a first time period. In the embodiment illustrated in FIG. 1, the water usage analyzer 118 receives the first data from the usage database 110. The water usage analyzer 118 may be owned or otherwise operated by the water supplier 102. Alternatively, the water usage analyzer 118 may be owned or otherwise operated by a separate entity. In this case, the separate entity may obtain access to data from one or more water suppliers and may perform analysis of the water usage data for commercial purposes (e.g., a server that uploads data from multiple water supplier systems). The first data may represent a total amount of water that is used at the first customer premises 104, at the second customer premises 106, and at the third customer premises 108 during the first time period. Water usage data may correlate with whether a customer is at home and potentially available to view a television program. The water usage analyzer 118 may be configured to estimate, based on the first aggregate amount of water used, a first number of potential television viewers during the first time period. The water usage analyzer 118 may be configured to receive second data that represents a second aggregate amount of water that is used by the plurality of customers during a second time period. The water usage analyzer 118 may be configured to estimate, based on the second aggregate amount of water used, a second number of potential television viewers during the second time period.

In a particular embodiment, the first time period may be associated with a television viewing period (e.g., a time period that corresponds to a movie, a television program, or a live event), and the second time period may be associated with a portion of the television viewing period (e.g., a commercial break portion). The water meters 112, 114, 116 may be able to provide water usage data to the water supplier 102 in substantially real-time (e.g., via telemetry). In this case, the water supplier 102 may have access to water usage data in substantially real-time (e.g., during the television viewing period). As an illustrative example, aggregate water usage during a first commercial break portion of a major sporting event that begins at 7 P.M. (e.g., a time period between 7:15 P.M. and 7:18 P.M.) may be lower than aggregate water usage during a second commercial break portion of the sporting event (e.g., a time period between 7:33 P.M. and 7:36 P.M.). Increased water usage may be associated with increased restroom visits (e.g., increased toilet flushes and hand washes). While in the restroom, an advertisement may not be viewed or heard. As such, increased aggregate water usage during the second commercial break portion of the sporting event may indicate that there are fewer potential television viewers during the second commercial break portion. As another example, the first time period may be associated with a first portion of a day (e.g., the morning), and the second time period may be associated with a second portion of the day (e.g., the evening). As a further example, the first time period may be associated with a first season of the year (e.g., summer), and the second time period may be associated with a second season of the year (e.g., winter).

One or more advertising fees may be adjusted based on a comparison of the first number of potential television viewers and the second number of potential television viewers. For example, aggregate water usage may decrease at regular intervals in a university town (e.g., between semesters). In this case, a comparison of aggregate water usage data may be used to estimate a change in a potential number of television viewers and an associated increase or decrease in advertising fees. Further, advertising content may be targeted to the plurality of customers based on the comparison of the first number of potential television viewers and the second number of potential television viewers. For example, a number of travel-related advertisements may be reduced when the aggregate water usage data indicates that many residents may be away on vacation.

In another embodiment, an amount of water used by a particular customer or a subset of customers may be used by the advertiser 120 to identify targeted advertising content. For example, the water usage analyzer 118 may be configured to receive water usage data that identifies a water consumption rate of each customer of the plurality of customers of the water supplier 102. The water usage analyzer 118 may be configured to compare the water consumption rate of a particular customer to a threshold water consumption rate. When the water consumption rate of the particular customer satisfies the threshold water consumption rate, a targeted advertisement may be identified that is to be communicated to the particular customer. As an example, the targeted advertisement may be associated with bottled water or a water filter. As another example, the targeted advertisement may be associated with water conservation. To illustrate, the targeted advertisement may be associated with a low-flow shower head, a low-flow toilet, or a sprinkler system. Further, multiple targeted advertisements may be communicated to an identified customer (e.g., a first advertisement associated with a low-flow shower head and a second advertisement associated with a low-flow toilet).

The water usage analyzer 118 may be further configured to compare the water consumption rate of the particular customer to a second threshold water consumption rate. When the water consumption rate of the particular customer satisfies the second threshold water consumption rate, a second targeted advertisement may be identified that is to be communicated to the particular customer. As an example, when the water consumption rate is low, the second targeted advertisement may be associated with an environmentally friendly product or service.

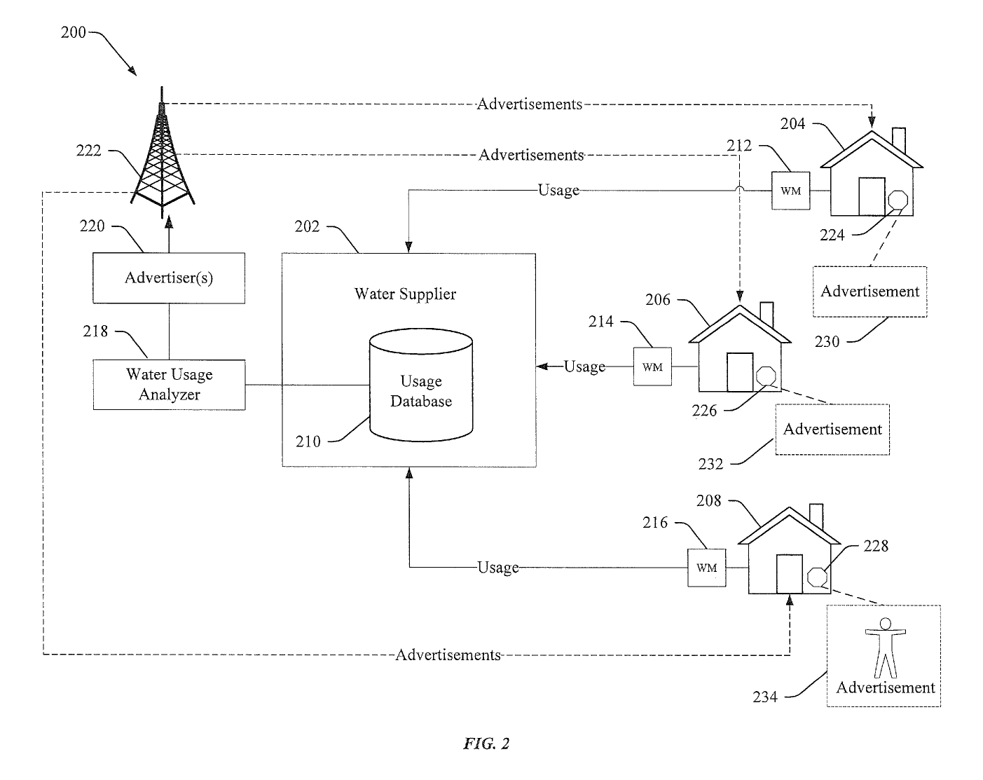

In a particular embodiment, an advertising fee associated with communication of the targeted advertisement may be adjusted based on a location of the particular customer. Further, an advertising fee associated with communication of the targeted advertisement may be adjusted based on demographic information associated with the particular customer or group of customers. The targeted advertisement may be provided electronically (e.g., via television, radio, email, text message, etc.) or may be provided to the customer by mail. Alternatively, the targeted advertisement may be displayed at an advertising display device that may be coupled to a water consumption device (e.g., a faucet) located at a customer premises (see FIG. 2).

FIG. 1 illustrates that aggregate water usage information may represent an additional source of data to be used when determining advertising fees and targeting advertisements. Further, individual water usage information (i.e., the amount of water used by a particular customer) may provide additional information to advertisers in order to target the particular customer when the water usage information satisfies a threshold water consumption rate. The water supplier 102 may be able to provide aggregate or individual water usage data and receive additional revenue at little or no cost, by making existing water usage data (e.g., data stored at the usage database 110) available to an interested company.

Referring to FIG. 2, a particular illustrative embodiment of a system of targeting advertisements based on a water usage analysis is illustrated and generally designated 200. In a particular embodiment, one or more components of the system 200 of FIG. 2 may correspond to one or more components of the system 100 of FIG. 1. The system 200 of FIG. 2 may utilize an aggregate amount of water consumed by a plurality of customers or an amount of water consumed by a particular customer or a subset of customers for identifying targeted advertisements to be delivered to one or more customers.

The system 200 includes a water supplier 202 that supplies water to a plurality of customers. For example, in the embodiment illustrated in FIG. 2, the water supplier 202 provides water to a first customer (e.g., at a first customer premises 204), to a second customer (e.g., at a second customer premises 206), and to a third customer (e.g., at a third customer premises 208). In alternative embodiments, the water supplier 202 may supply water to any number of customers. The system 200 includes a usage database 210 that stores water usage data associated with the plurality of customers. For example, a water consumption rate at the first customer premises 204 may be determined via a first water meter 212, a water consumption rate at the second customer premises 206 may be determined via a second water meter 214, and a water consumption rate at the third customer premises 208 may be determined via a third water meter 216. The system 200 further includes a water usage analyzer 218 that may utilize the water usage data stored at the usage database 210 to provide information to at least one advertiser 220.

In one embodiment, an aggregate amount of water used by the plurality of customers may be used by the advertiser 220 to identify the targeted advertising content. For example, the water usage analyzer 218 may be configured to receive data that represents an aggregate amount of water that is used by the plurality of customers during one or more time periods. In the embodiment illustrated in FIG. 2, the water usage analyzer 218 receives first data from the usage database 210 representing a total amount of water that is used at the first customer premises 204, at the second customer premises 206, and at the third customer premises 208.

In another embodiment, an amount of water used by a particular customer may be used by the advertiser 220 to identify targeted advertising content. For example, the water usage analyzer 218 may be configured to receive water usage data that identifies a water consumption rate of each customer of the plurality of customers of the water supplier 202. The water usage analyzer 218 may be configured to compare the water consumption rate of a particular customer of the plurality of customers to a threshold water consumption rate. When the water consumption rate of the particular customer satisfies the threshold water consumption rate, a targeted advertisement may be identified that is to be communicated to the particular customer. The water usage analyzer 218 may be further configured to compare the water consumption rate of the particular customer to a second threshold water consumption rate. When the water consumption rate of the particular customer satisfies the second threshold water consumption rate, a second targeted advertisement may be identified that is to be communicated to the particular customer. In a particular embodiment, an advertising fee associated with communication of the targeted advertisement may be adjusted based on a location of the particular customer. Further, an advertising fee associated with communication of the targeted advertisement may be adjusted based on demographic information associated with the particular customer.

In the embodiment illustrated in FIG. 2, advertisements may be delivered via a wireless network 222 to an advertising display device located at a customer premises. In a particular embodiment, the advertising display device may be coupled to a water consumption device (e.g., a faucet) located at the customer premises. As an illustrative example, a customer may receive a water purifier (to be coupled to the water consumption device) for free or at a reduced cost in exchange for receiving advertisements.

A first advertising display device 224 may be located at the first customer premises 204, a second advertising display device 226 may be located at the second customer premises 206, and a third advertising display device 228 may be located at the third customer premises 208. The first advertising display device 224 may display a first advertisement 230, the second advertising display device 226 may display a second advertisement 232, and the third advertising display device 228 may display a third advertisement 234. The advertisements 230, 232, 234 may include the same targeted advertising content or different targeted advertising content. The targeted advertising content may include audio content, video content, text content, or a combination thereof. To illustrate, the third advertisement 234 displayed via the third advertising display device 228 includes at least visual content (e.g., a still image or video).

FIG. 2 illustrates that aggregate water usage information may be used when targeting advertisements to one or more customers. Further, individual water usage information (i.e., the amount of water used by a particular customer) may be used to target the particular customer. In a particular embodiment, an advertising display device (e.g., coupled to a water consumption device) located at a customer premises may be used to communicate one or more targeted advertisements to the customer. The advertising display device (e.g., a water purifier) may be provided to the customer for free or at a reduced cost in exchange for the customer receiving advertisements.

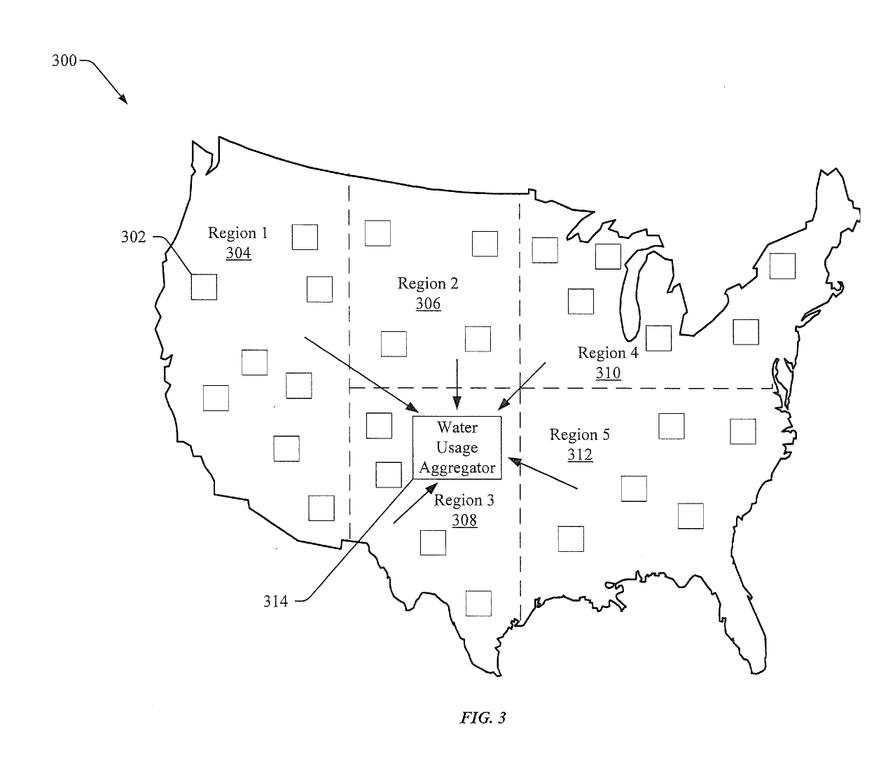

Referring to FIG. 3, a particular illustrative embodiment of a system of analyzing water usage over multiple geographic regions for advertising purposes is illustrated and generally designated 300. FIG. 3 illustrates that water usage data may be acquired from numerous locations to provide additional information to advertisers (e.g., water consumption patterns in different cities/states/regions).

FIG. 3 illustrates that a water supplier 302 that supplies water to a plurality of customers may be located in one of a plurality of geographic regions. In the embodiment illustrated in FIG. 3, the plurality of geographic regions includes a first geographic region 304, a second geographic region 306, a third geographic region 308, a fourth geographic region 310, and a fifth geographic region 312. Alternatively, any number of geographic regions may be used for analysis purposes. A water usage aggregator 314 may receive water usage data from at least two of the geographic regions 304, 306, 308, 310, and 312.

As an illustrative example, the water usage aggregator 314 may be configured to receive first water usage data associated with a first aggregate amount of water that is used by a first plurality of customers of one or more water suppliers that are associated with the first geographic region 304. The water usage aggregator 314 may be configured to receive second water usage data associated with a second aggregate amount of water that is used by a second plurality of customers of one or more water suppliers that are associated with the second geographic region 306. The water usage aggregator 314 may be configured to compare the first water usage data to the second water usage data.

The water usage aggregator 314 may be configured to identify a first targeted advertisement to be communicated to one or more devices located in the first geographic region 304 based on the comparison and to identify a second targeted advertisement to be communicated to one or more devices located in the second geographic region 306 based on the comparison. For example, the one or more devices may include one or more of a television, a radio, an advertising display device coupled to a water consumption device, and a telephone, among other alternatives. In a particular embodiment, a first advertising fee is associated with communication of the first targeted advertisement, and a second advertising fee is associated with communication of the second targeted advertisement. The first advertising fee may be different from the second advertising fee.

FIG. 3 illustrates that water usage data from numerous geographical locations obtained from multiple water suppliers may provide additional information to advertisers (e.g., water usage information for potential customers in various geographical locations) or to an intermediate party (e.g., an advertising broker). Water suppliers, such as the water supplier 302 in FIG. 3) may be able to provide aggregate or individual water usage data and receive additional revenue at little or no cost, by making existing water usage data available to an interested company (e.g., a company that utilizes the water usage aggregator 314).

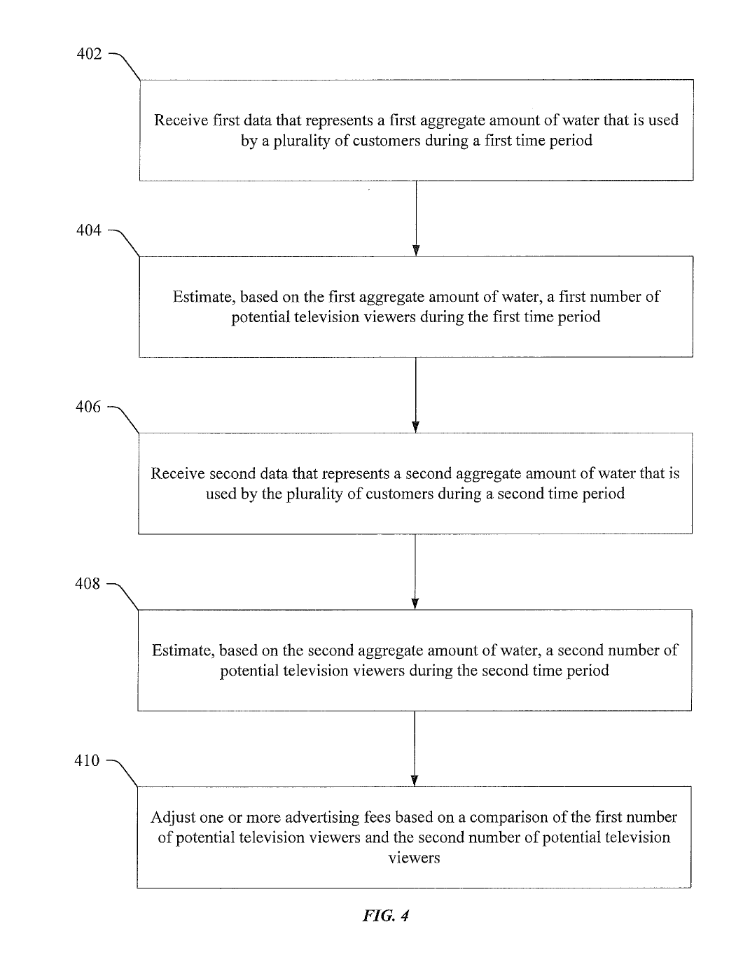

Referring to FIG. 4, a particular embodiment of a method of adjusting one or more advertising fees based on a comparison of an estimated number of potential television viewers during different time periods is illustrated.

The method includes receiving first data that represents a first aggregate amount of water that is used by a plurality of customers during a first time period, at 402. For example, the water usage analyzer 118 of FIG. 1 may receive first data from the usage database 110 that represents a total amount of water that is used by a plurality of customers during a first time period. To illustrate, in FIG. 1, the plurality of customers includes a first customer located at the first customer premises 104, a second customer located at the second customer premises 106, and a third customer located at the third customer premises 108. In alternative embodiments, the first aggregate amount of water may be associated with any number of customers.

The method includes estimating, based on the first aggregate amount of water, a first number of potential television viewers during the first time period, at 404. For example, the water usage analyzer 118 of FIG. 1 may estimate, based on the first aggregate amount of water, a first number of potential television viewers during the first time period. Based on the water usage data stored at the usage database 110, the water usage analyzer 118 may determine an aggregate amount of water used by the plurality of customers of the water supplier 102 during the first time period. Water usage data may correlate with whether a particular customer is at home and potentially available to view a television program. As such, an aggregate amount of water used by the plurality of customers during the first time period may correlate with a total number of customers that are at home and potentially available to view the television program during the first time period.

The method includes receiving second data that represents a second aggregate amount of water that is used by the plurality of customers during a second time period, at 406. For example, the water usage analyzer 118 of FIG. 1 may receive second data from the usage database 110 that represents a total amount of water that is used by a plurality of customers during a second time period. The method includes estimating, based on the second aggregate amount of water, a second number of potential television viewers during the second time period, at 408. For example, the water usage analyzer 118 of FIG. 1 may estimate, based on the second aggregate amount of water, a second number of potential television viewers during the second time period.

In one embodiment, the first period of time is associated with a television viewing period (e.g., an hour or a half-hour). The second time period may be associated with a commercial break portion of the television viewing period. In another embodiment, the first time period may be associated with a first portion of a day, and the second time period may be associated with a second portion of the day. The water meters 112, 114, 116 of FIG. 1 may use telemetry to provide water usage data to the water supplier 102 in order for the water supplier 102 to monitor water usage in substantially real-time. In another embodiment, the first time period may be associated with a first season of the year (e.g., spring), and the second time period may be associated with a second season of the year (e.g., summer).

The method includes adjusting one or more advertising fees based on a comparison of the first number of potential television viewers and the second number of potential television viewers, at 410. When the water usage data indicates that potential viewership is lower during a particular time period, an advertiser may be able to negotiate a reduced advertising fee for an advertisement during the particular time period. Similarly, when the water usage data indicates that potential viewership is higher during a particular time period, a television content provider or an advertisement selling agent (e.g., a television network or a local television station) may be able to negotiate an increased advertising fee for an advertisement during the particular time period.

FIG. 4 illustrates that aggregate water usage information may represent an additional source of data to be used when determining advertising fees. Further, a water supplier may be able to receive additional revenue at little or no cost, by making existing water usage data (e.g., data stored at the usage database 110) available to an interested company.

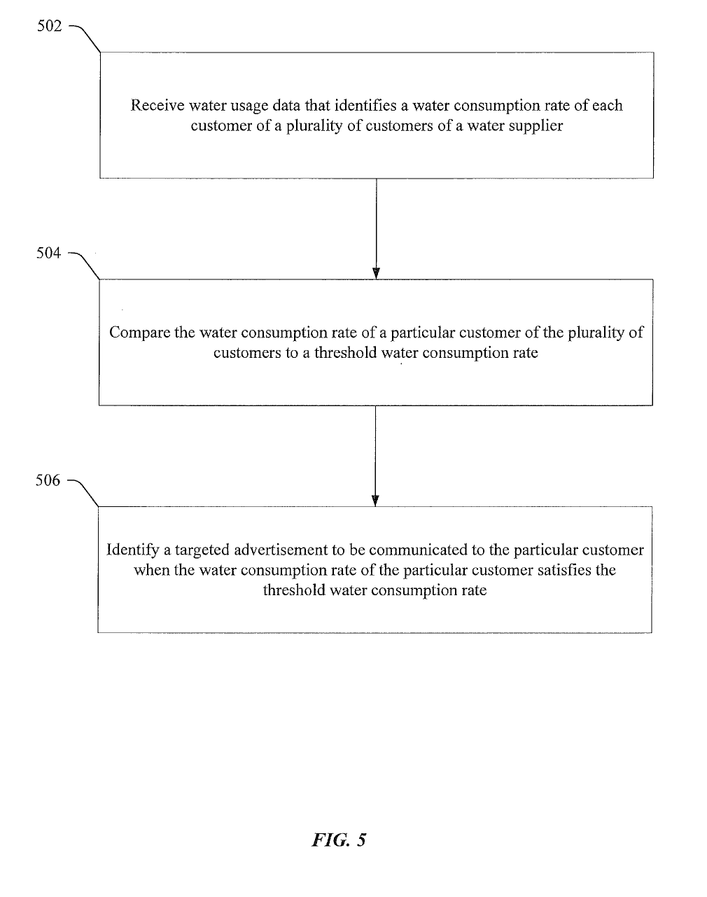

Referring to FIG. 5, a particular embodiment of a method of identifying a targeted advertisement based on a water consumption rate is illustrated.

The method includes receiving water usage data that identifies a water consumption rate of each customer of a plurality of customers of a water supplier, at 502. For example, the water usage analyzer 118 of FIG. 1 may receive water usage data from the usage database 110 that identifies a water consumption rate of each customer of a plurality of customers of the water supplier 102. To illustrate, in FIG. 1, the plurality of customers includes a first customer located at the first customer premises 104, a second customer located at the second customer premises 106, and a third customer located at the third customer premises 108. In alternative embodiments, the first aggregate amount of water may be associated with any number of customers.

The method includes comparing the water consumption rate of a particular customer of the plurality of customers to a threshold water consumption rate, at 504. To illustrate, the water usage analyzer 118 of FIG. 1 may compare the water consumption rate of the first customer at the first customer premises 104 to a threshold water consumption rate.

The method includes identifying a targeted advertisement to be communicated to the particular customer when the water consumption rate of the particular customer satisfies the threshold water consumption rate, at 506. For example, the threshold water consumption rate may be associated with a customer that uses a relatively large amount of water. In this case, the advertiser 120 of FIG. 1 may identify an advertisement that is targeted to a customer that uses a relatively large amount of water. For example, the advertiser 120 of FIG. 1 may identify a targeted advertisement associated with bottled water or a water filter. As another example, the advertiser 120 of FIG. 1 may identify a targeted advertisement associated with water conservation (e.g., an advertisement associated with a low-flow shower head, a low-flow toilet, or a sprinkler system).

FIG. 5 illustrates that individual water usage information (i.e., the amount of water used by a particular customer) may provide additional information to advertisers in order to target the particular customer when the water usage information satisfies a threshold water consumption rate or falls within a targeted usage range. As noted above, a water supplier may be able to receive additional revenue at little or no cost, by making the data available to an interested company.

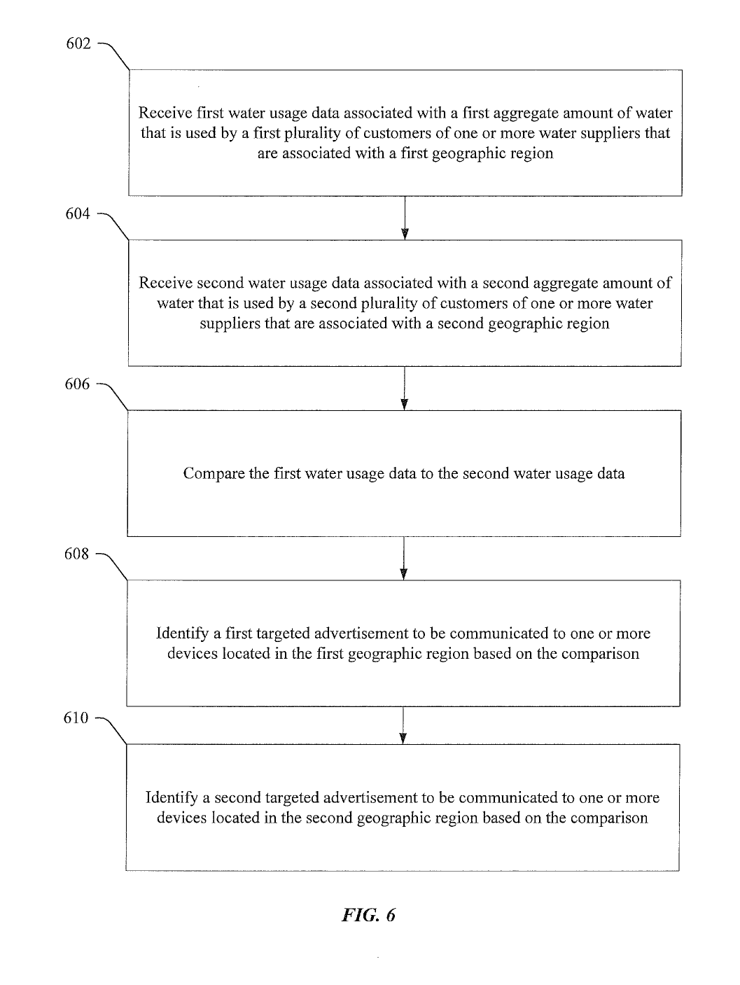

Referring to FIG. 6, a particular embodiment of a method of identifying a targeted advertisement to be communicated to one or more devices in a particular geographic region based on water usage data is illustrated.

The method includes receiving first water usage data associated with a first aggregate amount of water that is used by a first plurality of customers of one or more water suppliers that are associated with a first geographic region, at 602. For example, the water usage aggregator 314 of FIG. 3 may receive first water usage data associated with a first aggregate amount of water that is used by a first plurality of customers of one or more water suppliers that are associated with the first geographic region 304.

The method includes receiving second water usage data associated with a second aggregate amount of water that is used by a second plurality of customers of one or more water suppliers that are associated with a second geographic region, at 604. For example, the water usage aggregator 314 of FIG. 3 may receive second water usage data associated with a second aggregate amount of water that is used by a second plurality of customers of one or more water suppliers that are associated with the second geographic region 306.

The method includes comparing the first water usage data to the second water usage data, at 606. For example, the water usage aggregator 314 of FIG. 3 may compare the first water usage data (e.g., associated with the first geographic region 304) to the second water usage data (e.g., associated with the second geographic region 306).

The method includes identifying a first targeted advertisement to be communicated to one or more devices located in the first geographic region based on the comparison, at 608. For example, a first targeted advertisement may be identified that is to be communicated to one or more devices located in the first geographic region 304 based on the comparison. The method includes identifying a second targeted advertisement to be communicated to one or more devices located in the second geographic region based on the comparison, at 610. For example, a second targeted advertisement may be identified that is to be communicated to one or more devices located in the second geographic region 306 based on the comparison.

FIG. 6 illustrates that a regional/national aggregator may use a model to acquire data from numerous locations to provide additional information to advertisers. For example, advertisers may be able to compare water consumption patterns in different cities/states/regions and may be able to identify potential customers with high water usage rates in various locations.

Those of skill would further appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and features have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods or algorithms described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electronically erasable programmable read-only memory (EEPROM), registers, hard disk, a removable disk, a compact disc (CD) ROM, or any other form of tangible storage medium known in the art. An exemplary storage medium is coupled to the processor such that the processor can read information from, and write information to, the storage medium. In the alternative, the storage medium may be integral to the processor. The processor and the storage medium may reside in an application specific integration circuit (ASIC). The ASIC may reside in a computing device, a user terminal, or a telephone. In the alternative, the processor and the storage medium may reside as discrete components in a computing device, user terminal, or telephone.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope possible consistent with the principles and features as defined by the following claims.

What is claimed is:

1. A method, comprising:
receiving first data that represents a first aggregate amount of water that is used by a plurality of customers during a first time period;
estimating, based on the first aggregate amount of water, a first number of potential television viewers during the first time period;
receiving second data that represents a second aggregate amount of water that is used by the plurality of customers during a second time period;
estimating, based on the second aggregate amount of water, a second number of potential television viewers during the second time period; and
adjusting one or more advertising fees based on a comparison of the first number of potential television viewers and the second number of potential television viewers.

2. The method of claim 1, wherein the first time period is associated with a television viewing period.

3. The method of claim 2, wherein the second time period is associated with a portion of the television viewing period.

4. The method of claim 2, wherein the second time period is associated with a commercial break portion of the television viewing period.

5. The method of claim 1, wherein the first time period is associated with a first season of a year and wherein the second time period is associated with a second season of the year.

6. The method of claim 1, wherein the first time period is associated with a first portion of a day and wherein the second time period is associated with a second portion of the day.

7. The method of claim 1, further comprising targeting advertising content to the plurality of customers based on the comparison of the first number of potential television viewers and the second number of potential television viewers.

8. The method of claim 7, wherein the targeted advertising content comprises audio content, video content, text content, or a combination thereof.

9. The method of claim 7, wherein the targeted advertising content is sent to an advertising display device coupled to a water consumption device located at a customer premises.

10. A non-transitory computer readable storage medium comprising instructions that, when executed by a processor, cause the processor to:
receive water usage data that identifies a water consumption rate of each customer of a plurality of customers of a water supplier;
compare the water consumption rate of a particular customer of the plurality of customers to a threshold water consumption rate; and
identify a targeted advertisement to be communicated to the particular customer when the water consumption rate of the particular customer satisfies the threshold water consumption rate.

11. The non-transitory computer readable storage medium of claim 10, wherein the targeted advertisement is associated with one of bottled water and a water filter.

12. The non-transitory computer readable storage medium of claim 10, wherein the targeted advertisement is associated with water conservation.

13. The non-transitory computer readable storage medium of claim 12, wherein the targeted advertisement is associated with one of a sprinkler system, a low-flow shower head, and a low-flow toilet.

14. The non-transitory computer readable storage medium of claim 10, further comprising instructions that, when executed by the processor, cause the processor to:
compare the water consumption rate of the particular customer of the plurality of customers to a second threshold water consumption rate; and
identify a second targeted advertisement to be communicated to the particular customer when the water consumption rate of the particular customer satisfies the second threshold water consumption rate.

15. The non-transitory computer readable storage medium of claim 10, further comprising instructions that, when executed by the processor, cause the processor to adjust an advertising fee associated with communication of the targeted advertisement based on a location of the particular customer, demographic information associated with the particular customer, or a combination thereof.

16. The non-transitory computer readable storage medium of claim 10, further comprising instructions that, when executed by the processor, cause the processor to identify a second targeted advertisement to be communicated to a second customer when a second water consumption rate of the second customer satisfies the threshold water consumption rate.

17. A method, comprising:
receiving first water usage data associated with a first aggregate amount of water that is used by a first plurality of customers of one or more water suppliers that are associated with a first geographic region;
receiving second water usage data associated with a second aggregate amount of water that is used by a second plurality of customers of one or more water suppliers that are associated with a second geographic region;
comparing the first water usage data to the second water usage data;
identifying a first targeted advertisement to be communicated to one or more devices located in the first geographic region based on the comparison; and
identifying a second targeted advertisement to be communicated to one or more devices located in the second geographic region based on the comparison.

18. The method of claim 17, wherein a first advertising fee is associated with communication of the first targeted advertisement and wherein a second advertising fee is associated with communication of the second targeted advertisement.

19. The method of claim 18, wherein the first advertising fee is different from the second advertising fee.

20. The method of claim 17, wherein the one or more devices include at least one of a television, a radio, an advertising display device coupled to a water consumption device, and a telephone.
